(19) United States
(12) Patent Application Publication
(10) Pub. No.: US 2006/0100760 A1
(43) Pub. Date: May 11, 2006

(54) Device for determining the actual vehicle speed

(76) Inventors: Reiner Marchthaler, Gingen (DE); Frank Mack, Stuttgart (DE); Alfred Kuttenberger, Moeglingen (DE)

Correspondence Address: KENYON & KENYON LLP, ONE BROADWAY, NEW YORK, NY, 10004, US

(21) Appl. No.: 10/517,508

(22) PCT Filed: Jul. 8, 2004
(86) PCT No.: PCT/DE04/01480

§ 371 Date: Dec. 13, 2005

(30) Foreign Application Priority Data
Jul. 15, 2003 (DE) 103 31 965.4

(51) Int. Cl. G05D 1/00

(52) U.S. Cl. 701/45; 701/1

(57) ABSTRACT

An apparatus for determining inherent vehicle velocity determines the inherent vehicle velocity using the pre-crash sensor suite. The determination is performed on the basis of signals reflected from road surfaces. The determination is performed only when a predefined operating state exists, such as a locked, slipping or suspended wheel.

### BACKGROUND INFORMATION

It is known from German Patent Application No. DE 39 09 644 to perform a measurement of the inherent velocity of a vehicle in accordance with the Doppler radar principle, a signal reflected from the ground being utilized.

### SUMMARY OF THE INVENTION

The apparatus according to the present invention for determining inherent vehicle velocity has the advantage that the evaluation of inherent vehicle velocity by means of a pre-crash sensor suite on the basis of signals reflected from the ground is used only when a predefined operating state exists. This predefined operating state may be, for example, locked wheels, slipping wheels, or wheels suspended in the air. The reason is that these operating states mean that a measurement of the inherent velocity by way of wheel rotation speed fails. The inherent velocity measurement is therefore then performed using the pre-crash sensor suite on the basis of signals reflected from the ground.

It is particularly advantageous that the pre-crash sensor suite has a radar sensor suite. It is furthermore advantageous that the apparatus compares the signal reflected from an object with the inherent vehicle velocity in such a way as to classify the object. Specifically, if the object possesses, on the basis of the reflected signals, a relative motion with respect to the vehicle that is equal to the inherent velocity, it is then a stationary object. That stationary object could then also be used to determine the inherent velocity.

### BRIEF DESCRIPTION OF THE DRAWINGS

FIG. 1 shows a manner of operation of the apparatus according to the present invention.

FIG. 2 is a block diagram of the apparatus according to the present invention.

FIG. 3 is a first flow chart.

FIG. 4 is a second flow chart.

### DETAILED DESCRIPTION

In an airbag algorithm at present, signals from impact sensors such as acceleration sensors are evaluated. The relative velocity between the vehicle and a crash object, as well as the inherent velocity, are important parameters for obtaining a better determination of the triggering time. These parameters can be ascertained by means of a pre-crash sensor suite. Usually, however, the inherent velocity is determined in the ESP/ABS control unit by means of wheel rotation speeds. This information is no longer correct, however, in certain operating states such as locked or spinning or suspended wheels.

The inherent velocity is an important variable for ESP/ABS function. An exact estimate in critical situations, e.g. locked wheels, thus also improves vehicle stability.

It is consequently provided according to the present invention to determine the inherent vehicle velocity in such operating states by means of the pre-crash sensor suite. This is accomplished on the basis of signals reflected from the ground, i.e. from the road surface. Because the distance and angle of the radar beams with respect to the road surface is constant, the signal time from transmission to reception is an indication of the inherent velocity of the vehicle.

Because of the wide opening angle of the pre-crash sensor, in addition to the actual usable signals from oncoming or stationary obstacles, signal components deriving from the road are also obtained. From these constantly present signal components, the inherent velocity of the vehicle can then be calculated. The pre-crash sensor suite can advantageously use a radar sensor suite here, but it is also possible to use an ultrasonic sensor suite or lidar technology, or other signals that are emitted and reflected back.

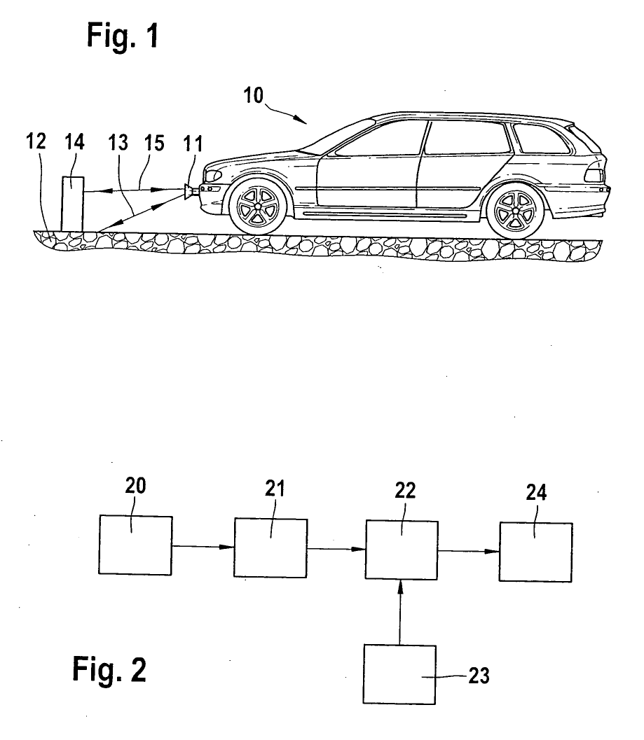

FIG. 1 shows the manner of operation of the apparatus according to the present invention. A vehicle 10 has a pre-crash sensor suite 11, here a radar sensor suite, which here emits, for example, radar beams 13 and 15. Radar beam 13 is reflected from road surface 12, while radar beam 15 is reflected from object 14. Because the angle of radar beam 13 with respect to the road is always the same, the signal transit time from radar sensor 11 to road 12 is always the same. The signal transit time thus provides an indication of the inherent vehicle velocity. The signal transit time with respect to obstacle 14 drops with decreasing distance. The signal sequence of the reflected signals is, however, likewise an indication of the inherent vehicle velocity if obstacle 14 is not moving. A classification of obstacle 14 is thus possible.

FIG. 2 is a block diagram of the apparatus according to the present invention. A pre-crash sensor suite 20 is connected to a signal processing system 21. Signal processing system 21 amplifies, filters, and digitizes the signals of pre-crash sensor suite 20. The digital signals are then transferred from signal processing system 21 to a control unit 22. This control unit 22 is in this case, by way of example, the control unit for the restraint means. A wheel rotation speed sensor suite 23 also, however, transfers to control unit 22 a signal that represents the inherent vehicle velocity. If it is then detected by means of the vehicle dynamics control system that a wheel is slipping or locked or suspended, airbag control unit 22 then uses the signals of pre-crash sensor suite 20 to determine the inherent vehicle velocity. The inherent vehicle velocity is an important parameter for determining the severity of a crash. As a function thereof, control unit 22 then activates restraint means 24. Restraint means 24 include airbags, belt tensioners, or roll bars.

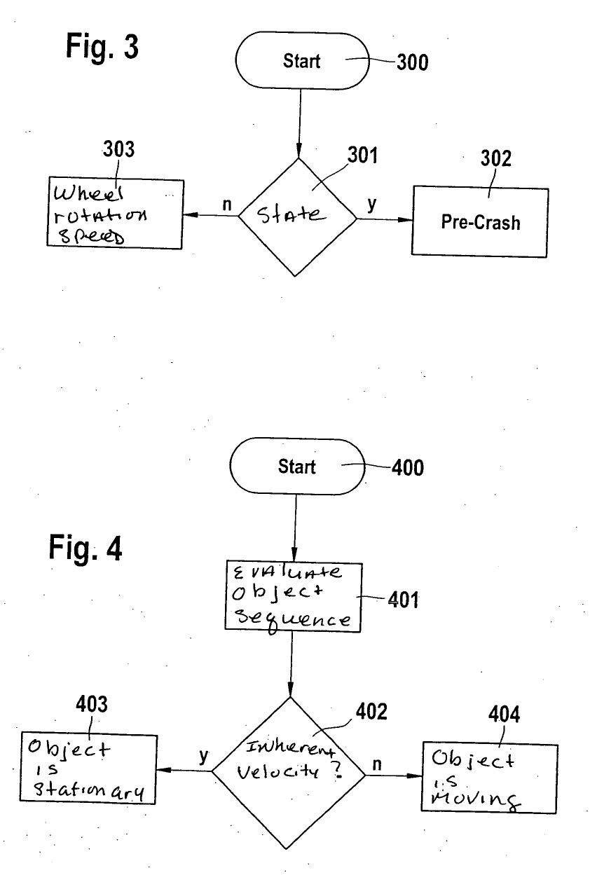

FIG. 3 explains the manner of operation of the apparatus according to the present invention in a first flow chart. The method begins at method step 300. Method step 301 checks, specifically on the basis of data from a vehicle dynamics control system or an ABS control unit, whether a condition exists that necessitates determination of the inherent velocity by means of the pre-crash sensor suite. These conditions include those that make it impossible to determine the inherent velocity on the basis of wheel rotation speed. These are locked, slipping, or suspended wheels. If such is not the case, then in method step 303 the inherent velocity is determined on the basis of wheel rotation speed. If it is the case, however, then in method step 302 the inherent velocity is determined as presented above on the basis of the pre-crash sensor suite, based on the signal reflected from the road surface.

FIG. 4 explains the manner of operation of the apparatus according to the present invention in a second flow chart. The method begins at method step 400. In method step 401, an evaluation is performed of signals reflected from an object. The evaluation is made in such a way that the velocity of the object sequence is evaluated. The reason is that the inherent velocity of the vehicle can therefore be determined if the object is stationary. Method step 402 consequently evaluates whether the velocity that can be determined on the basis of the object sequence corresponds to the inherent velocity. If such is the case, method step 403 then establishes that the object is stationary. If it is not the case, method step 404 then establishes that the object is moving.

When the beam component reflected back from the road is evaluated, what is obtained is an object that is always at the same distance in front of the vehicle. It is made up of a sequence of objects that are moving toward the vehicle. When the velocity of the object sequence is then evaluated, it is then found to correspond to the inherent velocity. Because of the fixed distance of the object and the object velocity that is directed toward the vehicle, the object can be distinguished from crash-relevant objects and thus employed for determination of the inherent velocity.

1-4. (canceled)

5. An apparatus for determining inherent vehicle velocity, comprising:
a pre-crash sensor suite for determining the inherent vehicle velocity, the pre-crash sensor suite being configured in such a way that when a predefined operating state exists, the pre-crash sensor suite determines the inherent vehicle velocity as a function of a signal reflected from the ground.

6. The apparatus according to claim 5, wherein the pre-crash sensor suite has a radar sensor suite.

7. The apparatus according to claim 5, wherein the operating state is a locked wheel.

8. The apparatus according to claim 5, wherein the operating state is a spinning wheel.

9. The apparatus according to claim 5, wherein the operating state is a suspended wheel.

10. The apparatus according to claim 5, further comprising an arrangement for comparing signals reflected from an object with the inherent vehicle velocity in such a way that the object is classified.
